(19) United States
(12) Patent Application Publication
(10) Pub. No.: US 2026/0350070 A1
(43) Pub. Date: Nov. 5, 2026

(54) GENERATING QUERY RESPONSES USING MULTI-DOCUMENT RETRIEVAL AUGMENTED GENERATION

(71) Applicant: Goldman Sachs & Co. LLC, New York, NY (US)

(72) Inventor: Giovanni Faonte, Jersey City, NJ (US)

(21) Appl. No.: 19/199,192

(22) Filed: May 5, 2025

(51) Int. Cl. G06F 16/334; G06F 16/3329; G06F 16/3332; G06F 16/383

(52) U.S. Cl. CPC G06F 16/334; G06F 16/3329; G06F 16/3334; G06F 16/383

(57) ABSTRACT

The systems and methods describe provide a model structure and system for generating improved responses to natural language queries made to a database, leveraging a Retriever-Augmented Generation (RAG) approach within a larger language model (LLM). The system includes modules for ingestion, query filtering, data object selection and aggregation, and response generation. The model structure establishes domain or context-specific filters and employs an embedding based search for the query, selecting relevant data objects or portions thereof. An aggregate data object composed of selected relevant data objects is created. This aggregate data object contains high-probability domain-specific information pertinent to answering the information request. Leveraging this localized aggregate data object, the information retrieval model, such as LLM, can provide responses having improved contextual, semantic, and intentional relevance.

### BACKGROUND

### Field of Disclosure

The present invention relates generally to the field of database queries and machine learning. More specifically, this invention relates to generating responses to database queries using a large language model utilizing multi-document retrieval augmented generation.

### Description of the Related Art

The field of artificial intelligence, specifically natural language processing and machine learning, has seen significant advancements over recent years. With these advancements, the computational ability to understand, interpret, and generate human-friendly responses to a given query has increased dramatically.

To enable these capabilities, systems often utilize language models, which are statistical models that analyze the words in a dataset to generate a statistically probably response to a natural language query. Recently, the use of Large Language Models (LLMs) employing retrieval augmented generation (RAG) has gained prominence, offering vast improvements in query understanding and response generation.

However, RAG enabled LLMs often encounter challenges when trying to handle complex natural language queries. Specifically, these models can struggle with the mismatch of query context, understanding multi-faceted complex queries, the quality of retrieved information, and embedding drift. Thus, while these existing models offer improvements in some respects, they also present challenges that limit their optimal functionality. Therefore, there's a need for a system that overcomes these obstacles while leveraging the advantages of existing LLMs to provide more accurate and effective responses to information requests.

### SUMMARY

In some aspects, the techniques described herein relate to a method for generating a database response for an information query, the method including: receiving, at a network system from a client device, a database request including the information query, the information query a natural language request for information from for a plurality of documents in a document database; determining a relevant set of documents from the plurality of documents in the document database, the relevant documents determined by comparing embeddings generated to represent the natural language request for the information query to embeddings representing a content of each document in the plurality of documents; for each document in the relevant set of documents: identifying a plurality of document portions in the document pertaining to the information query; selecting one or more document portions of the plurality of document portions as relevant document portions, the relevant document portions providing at least a partial response to the information query; and extracting the relevant document portions providing at least a partial response to the information query to a corpus of relevant document portions; aggregating the relevant document portions in the corpus into an aggregated document; applying a large language model to the aggregated document to determine a response to the information query; and providing, from the network system to the client device, the response to the information query as the database response.

In some aspects, the techniques described herein relate to a method, wherein the information query includes a request to compare a first topic and a second topic.

In some aspects, the techniques described herein relate to a method, further including: generating, based on the natural language request including the information query, a first sub-query configured identify relevant information regarding the first topic; and generating, based on the natural language request including the information query, a second sub-query configured to identify relevant information regarding the second topic.

In some aspects, the techniques described herein relate to a method, wherein identifying a set of relevant documents includes: selecting a first subset of documents of the plurality by comparing embeddings generated to represent the first sub-query to embeddings representing the content of each document in the plurality of documents; and selecting a second subset of documents of the plurality by comparing embeddings generated to represent the second sub-query to embeddings representing the content of each document in the plurality of documents.

In some aspects, the techniques described herein relate to a method, wherein extracting relevant document portions providing at least the partial response to the information query includes: identifying a first subset of document portions in the first subset of documents pertaining to the first sub-query; selecting a first set of relevant document portions from the first subset of document portions that provide at least a partial response to the first sub-query; and extracting the first set of relevant document portions providing at least the partial response to the first sub-query to the corpus of relevant document portions.

In some aspects, the techniques described herein relate to a method, wherein extracting relevant document portions providing at least the partial response to the information query includes: identifying a second subset of document portions in the second subset of documents pertaining to the second sub-query; selecting a second set of relevant document portions from the second subset of document portions that provide at least a partial response to the second sub-query; and extracting the second set of relevant document portions providing at least the partial response to the second sub-query to the corpus of relevant document portions.

In some aspects, the techniques described herein relate to a method, wherein applying the large language model to the aggregated document to determine the response to the information query includes: determining a first response to the first sub-query; determining a second response to the second sub-query; and generating the response based of the first response and the second response.

In some aspects, the techniques described herein relate to a method, wherein identifying the plurality of document portions, selecting the one or more document portions, and extracting the relevant document portions providing at least a partial response to the information query to the corpus of relevant document portions includes performing retrieval augmented generation.

In some aspects, the techniques described herein relate to a method, wherein selecting the one or more document portions as relevant document portions includes: determining a relevancy of each document portion of the plurality of document portions; and selecting the one or more document portions as relevant documents whose relevancy is above a threshold relevancy.

In some aspects, the techniques described herein relate to a method, wherein identifying the relevant set of documents from the plurality of documents in the document database includes: determining a relevancy of each document of the plurality of documents; and selecting one or more of the plurality of documents for the relevant set of documents when the relevancy for the document is above a threshold relevancy.

In some aspects, the techniques described herein relate to a method for generating a database response for an information query for an entity, the method including: receiving, at a network system from a client device, a database request including the information query for the entity, the information query a natural language request for information from for a plurality of documents in a document database; determining a set of relevant documents from the plurality of documents in the document database based on the natural language request for the information query; extracting a plurality of relevant document portions that provide at least a partial response to the information query from the set of relevant documents; for each of the relevant document portions, determining a sentiment level for the entity in the relevant document portion using a large language model; determining a sentiment score for the entity based on the sentiment levels for the entity determined from the relevant document portions; aggregating the relevant document portions into an aggregate document; determining, by applying the large language model to the aggregated document, a response to the information query about the entity, wherein the response determination uses the sentiment score for the entity; providing, from the network system to the client device, the response to the information query for the entity as the database response, wherein the response reflects the sentiment score for the entity.

In some aspects, the techniques described herein relate to a method, wherein determining the set of relevant documents from the plurality of documents includes comparing embeddings generated to represent the natural language request for the information query to embeddings representing a content of each document in the plurality of documents.

In some aspects, the techniques described herein relate to a method, wherein extracting the plurality of relevant document portions includes: for each document in the relevant set of documents: identifying a plurality of document portions in the document pertaining to the information query; selecting one or more document portions of the plurality of document portions as relevant document portions, the relevant document portions providing at least a partial response to the information query; and extracting the relevant document portions providing at least a partial response to the information query to a corpus of relevant document portions.

In some aspects, the techniques described herein relate to a method, further including: determining, based on the natural language in the natural language request, a sentiment factor for determining sentiment levels in the set of relevant documents.

In some aspects, the techniques described herein relate to a method, wherein the sentiment factor is entity risk or public opinion.

In some aspects, the techniques described herein relate to a method, wherein the sentiment score is an aggregation of the sentiment levels from the set of relevant document portions.

In some aspects, the techniques described herein relate to a method, wherein determining sentiment levels for each of the relevant document portions includes generating a prompt for the large language model configured to increase a likelihood of accurate sentiment determination.

In some aspects, the techniques described herein relate to a method, wherein the prompt includes a request for providing a reasoning for the determined sentiment level.

In some aspects, the techniques described herein relate to a method, wherein the prompt includes a request for identifying portions relevant document portions leading to determined sentiment level for the document portion.

In some aspects, the techniques described herein relate to a method wherein determining the sentiment score for the entity based on the sentiment levels includes applying the large language model to the sentiment levels.

The methods described herein may be implemented by computer program instructions stored on a non-transitory computer-readable storage medium. The computer program instructions, when executed by one or more processors, may cause the one or more processors to execute the computer program instructions and perform the method.

The methods described herein may be implemented on a system. The system may include a non-transitory computer readable storage medium and one or more processors. The non-transitory computer-readable storage medium stores computer program instructions for implementing the method. The computer program instructions, when executed by the one or more processors, may cause the one or more processors to execute the computer program instructions and perform the method.

### BRIEF DESCRIPTION OF DRAWINGS

FIG. 1 illustrates a system environment configured for dynamically querying a database, according to an example embodiment.

FIG. 2 illustrates one embodiment of a client device that may be used to interact with the network system.

FIG. 3 illustrates an embodiment of the query module, according to an example embodiment.

FIG. 4 illustrates an example workflow of a query module providing query response in response to receiving a database query, according to an example embodiment.

FIG. 5 illustrates an example workflow of a query module providing a query response in response to receiving a query request, according to an example embodiment.

FIG. 6A shows a workflow for generating a database response to an information query, according to an example embodiment.

FIG. 6B shows a workflow for generating a database response to an information query about an entity, according to an example embodiment.

FIG. 7 is a block diagram illustrating components of an example machine for reading and executing instructions from a machine-readable medium, according to an example embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### I. Introduction

A system and model structure for providing improved responses to natural language queries to a database is described. The system and model structure enable multi-document retrieval augmented generation (“RAG”) in a manner that provides a large language model (“LLM”) with improved contextual and relevant information for answering a query.

The disclosed system and methods offer an improvement relative to more traditional RAG enabled LLM systems. Indeed, in recent times, the use of LLMs that implement RAG algorithms has seen a substantial increase, predominantly in the domain of querying databases for information extraction. The rationale behind the adoption is rooted in the methodology's ability to increase the versatility of an LLM in retrieving information. More specifically, RAG enables an LLM to utilize a database that has been preprocessed to codify the knowledge therein (e.g., via embeddings). By integrating retrieval of relevant information (e.g., using the embeddings) directly into the LLM generation procedure, RAG extends the capacity of traditional language models by offering a type of “contextual dataset” to the LLM. The contextual dataset enhances the LLM's ability to provide relevant and accurate responses based on that contextual dataset (e.g., a large set of reference documents).

However, even with the adoption of RAG-assisted LLMs on an upward trend, these models are not without their fair share of problems that hinder optimum functionality. Among these challenges are issues associated with the context mismatch and the quality and relevance of retrieved information. Moreover, embedding drift-the phenomenon where even slight changes in the data distribution leads to significant alterations in the learned embedding-presents additional problems, consequently necessitating domain adaptation measures.

More specifically, the issue of context mismatch and relevance pertains to the limitations of RAG models in appropriately understanding the context of a query and fetching the pertinent information. Given the complexity and variability of natural language, these models can fail to accurately match the query's implicit context with the context of the reference text. This often leads to a lack of coherence between the retrieved information and the query, undermining the quality and relevance of responses.

Additionally, embedding drift is a substantial technical challenge that suggest navigational methods for domain adaptation would be useful. As models are trained on a distribution of data, changes in data distribution—such as transformations in language patterns within a domain (such as a company name change, a change of an officer, etc.), significant changes in the dataset relevant to a domain (e.g., a market collapse, new regulations, etc.)-can significantly alter the learned embeddings. This drift can cause inconsistency and instability in the model responses. Consequently, there arises a need for domain adaptation techniques which adapt the model's structure to respond consistently despite changes in data distribution.

Given these shortcomings, there is a pressing need for an improved model structure capable of mitigating these issues. Such a structure should leverage the advantages of RAG in assisting an LLM, while bolstering the ability of these models to deliver more correct responses to information requests. One such model structure is described hereinbelow.

### II. System Environment

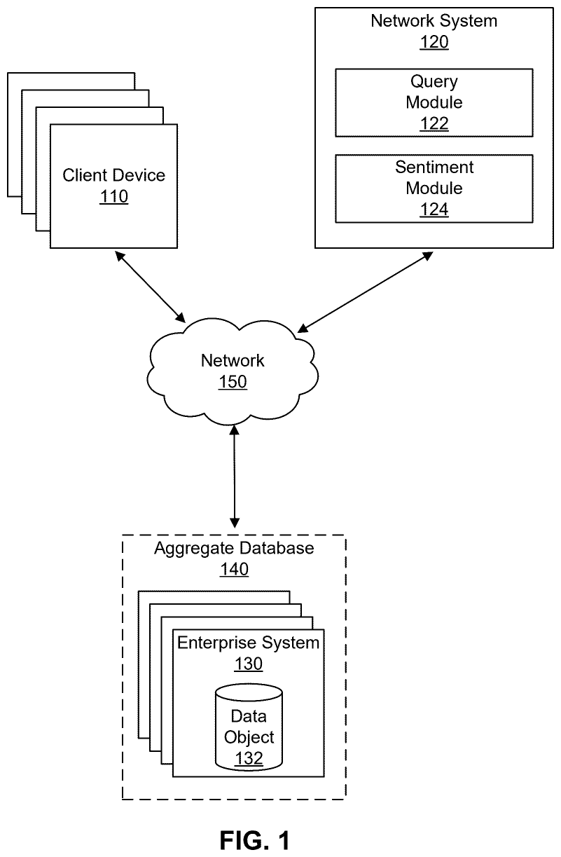

FIG. 1 illustrates a system environment configured for dynamically querying a database and providing a query response, according to an example embodiment. In the illustrated example, the system environment 100 includes a client device 110, a network system 120, an enterprise system 130 that form an aggregate database 140 and a network. The network system 120 includes a query module 122 and a sentiment module 124. Each enterprise system 130 may include one or more data objects 132. The system environment 100 may include one or more client devices 110 (e.g., 1, 2, 3, 5, . . . , N client devices) and/or may include one or more enterprise system 130 (e.g., 1, 2, 3, 5, . . . , N enterprise systems). Some embodiments of system environment 100 have different systems and modules than those described herein. Similarly, functions of the systems and modules can be distributed within the system environment 100 in a different manner than is described herein.

Within the system environment 100, the network system 120 generates a database query response (“query response”) in response to receiving a database query request (“query request”) from a client device 110. A query request is a request for information, and information response (and/or relevant) to the query response may be stored in the aggregate database 140.

Usually, a query request is a natural language input from a user using the client device 110A, and a query response is a response generated by the network system 120 that provides that information. In various configurations, the query response may be a response including, e.g., the requested information, a visualization of the requested information, a natural language version of the requested information, etc.

In an example, the query request may describe a request for, e.g., a comparison of a two metrics for two entities. To that end, the query request may be, e.g., “What are the differences between Metrics 1 and Metrics 2 at Entity A and Entity B?” Given this query request, the query response may be a natural language response that describes and details the differences between both Metrics 1 and Metrics 2 between Entity A and Entity B. As an express example to the query above, the query response may be, e.g., “For Metrics 1, Entity A outperformed Entity B, on average, for the past three quarters, while Entity B outperformed Entity A for all preceding quarters. For Metrics 2, it is difficult to identify any differences between the two, as Entity A does not provide information on Metrics 2. However, using relevant information provided by other Entities in the field, Entity A and Entity B probably perform similarly for Metrics B.”

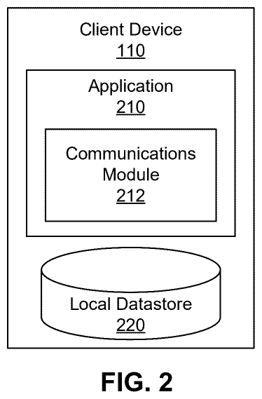

The client device 110 can be any computing device configured to interact with the query module 122. Although FIG. 1 shows several client devices 110, the system environment 100 may include any number of such devices. The client devices 110 present one or more user interfaces via which users may generate query requests and view query responses. Various embodiments of the client devices 110 and user interfaces are described in greater detail below, with reference to FIG. 2.

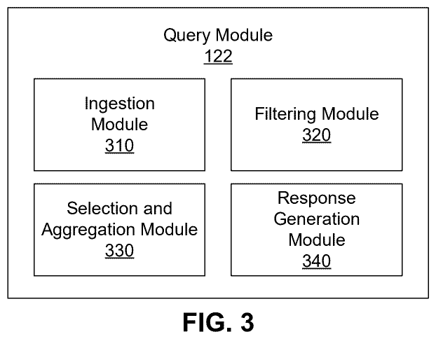

The network system 120 may utilize the query module 122 to generate a query response that includes the information requested in a query request. At a high level, the query module 122 receives a query request that includes a natural language request for information from a client device 110, processes the natural language query into an embedding, retrieves portions of data objects (e.g., sections of documents) likely to include information relevant to (or responsive to) the request for information, aggregates the relevant, retrieved portions, employs a large language to generate a response to the information request, and provides the generated response as a query response to the client device 110. Details of the query module 122 and the corresponding process are provided below in regard to FIGS. 3-6 below.

In generating the query response, the network system 120 may employ sentiment module 124 to perform and utilize sentiment analysis in generating a query response. For instance, the sentiment module 124 may analyze the natural language of the relevant document portions for their sentiment and determine a sentiment level for each document portion using a model (e.g., an LLM). The sentiment levels may be aggregated into a sentiment score. As described below, sentiment levels may be determined for various sentiment factor (e.g., risk, opinion, etc.). When generating the query response for the information request, the network system 120 may utilize the determined sentiment score to influence the determined query response.

To illustrate, consider an example where the query request includes a natural language request for information about an entity (e.g., Company A). As noted above, query module 122 retrieves relevant document portions based on the query request (e.g., those about Company A). Sentiment module 124 analyzes the sentiment of each of the relevant document portions and generates a sentiment score for the entity based on the analysis. Query module 122 may utilize the sentiment score for the entity when generating a query response to the query request. For instance, the sentiment score may color how the information is presented to the user, consider risk associated with entity based on the sentiment, etc.

An enterprise system 130 is one or more systems or databases connected to the network system 120 within the system environment 100 that include one or more data object 132 storing information that may be relevant for responding to query requests. The data object 132 in the enterprise system(s) 130 may be, e.g., a document, a video, a visualization, etc. For purposes of illustration, the description will focus on data objects 132 that are documents, but they could be any data object whose information may be described by an embedding. Stated differently, an enterprise system 130 may include information necessary to generate a query response for a query request generated by a client device 110, in whatever format may be applicable.

In aggregate, information stored in the data objects 132 in the enterprise system(s) 130 form an aggregate database 140. The aggregate database 140 includes underlying data that is used for generating a query response including a response to the requested information. Although the aggregate database 140 is shown as a distinct entity, the aggregate database may be part of the network system 120 and/or may reside on a different network. Whatever the case, the aggregate database represents the wealth of information the query module 122 may draw on when generating a query response.

Data objects 132 in the aggregate database 140 can describe a multitude of topics, and each data object 132 itself can describe multiple topics. In one embodiment, the data comprises data structures describing financial data or trends (e.g., asset prices, entity finances, etc.), but the disclosed techniques can be applied to any corpus of data for which may be queried and for which responses may be provided. In the case of financial data, the aggregate database 140 may include information about each transaction made on one or more exchanges involving one or more assets that are tracked by the query module 122. The information for a transaction may include the asset or assets traded, the price, a timestamp indicating when the transaction occurred, and derived data, such as volatility surfaces and discount curves. The information for the transaction may include additional data, such as an identifier of the buyer, an identifier of the seller, an identifier of the trading platform or exchange through which the transaction occurred, etc. Moreover, the transaction data may be associated with additional information relevant to the transaction such as, e.g., market sentiment, contextual information, and data relevant to the transaction, pertinent regulations, etc.). The aggregate database 140 may receive market data (e.g., from computing systems of the exchanges or trading platforms) in periodic batches (e.g., once an hour or once a day). Additionally, or alternatively, market data may be received in one or more continuous or semi-continuous data streams, or on demand, etc.

Additionally, the data in each data object 132 may include latent information reflecting the sentiment about various topics included in that data object. That is, the contextual tone, language choice, structure, etc. of data in a data object 132 may reflect the sentiment about one or more topics in the data object. For example, the tone of the language of a data object may reflect a positive sentiment towards a topic for a first entity and a negative sentiment for the topic for a second entity. Similarly, the structure and language choice of a data object 132 may reflect a positive sentiment for a first topic related to an entity and a negative sentiment for a second topic related to an entity. Other examples are also possible.

As shown in FIG. 1, client device 110, network system 120, enterprise system 130, are in communication with one another via a network(s) 150. In one embodiment, the network 150 is the Internet or any combination of a LAN, a MAN, a WAN, a mobile, wired or wireless network, a private network, or a virtual private network. The network 150 provides the communication channels via which the other elements of the networked computing environment 100 communicate. The network 150 can include any combination of local area and wide area networks, using wired or wireless communication systems. In one embodiment, the network 150 uses standard communications technologies and protocols. For example, the network 150 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, some or all of the communication links of the network 150 may be encrypted using any suitable technique or techniques.

### Client Device

FIG. 2 illustrates one embodiment of a client device 110 that may be used to interact with the network system 120. In the illustrated example, the client device 110 includes an application 210 (“app”) and a local datastore 220. In other embodiments, the client device 110 includes different or additional elements. In addition, the functions may be distributed among the elements in a different manner than described.

The application 210 is software that executes on the client device 110 to enable interaction with the query module 122. The application 210 may include a communications module 212. The communications module 212 sends query requests to the network system 120 over the network 150 and receives/processes query responses from the network system 120 in response. The local datastore 220 includes one or more computer-readable media that store the data used by the client device 110. For example, the local datastore 220 may include cached copies of data used in generating query requests and/or query responses.

### Query Module

As described above, network system 120 includes query module 122. The query module 122 receives query requests from a client device 110 via the network 150 and sends query responses to the client device 110 via the network 150 in response.

FIG. 3 illustrates an embodiment of the query module, according to an example embodiment. In the embodiment shown, the query module 122 includes an ingestion module 310, a query filtering module (e.g., “filtering module 320”), a data object selection and aggregation module (e.g., “selection module 330”), and a response generation module (e.g., “response module 340”). In other embodiments, the query module 122 includes different or additional elements. In addition, functions of the query module 122 may be distributed among the elements in a different manner than described, and/or the functions may be distributed within the system environment 100 in a different manner than described.

The query module 122 includes an ingestion module 310. The ingestion module 310 obtains data regarding one or more domains (e.g., from the aggregate database 140). Domains, at a high level, represent one or more contextually, semantically, intentionally, etc. distinguishable subsets of data within the aggregate database 140. When generating the aggregate database, the network system 120 may input data from various sources and appropriately classify it into a domain using, e.g., a language model (e.g., small or large).

To illustrate, in the case of data objects 132 comprising market data and associated contextual data, the ingestion module 310 may obtain documents relating to the market data (e.g., interviews, articles, reports, etc.) that are contextually relevant to the domain. Additionally, ingestion module 310 may obtain raw price data for assets, metrics calculated from the raw price data (e.g., maximum, minimum, opening, and closing prices), contextually relevant data to the market (e.g., articles, reviews, texts, etc.), etc. present in the aggregate database 140. In cases where raw price data is obtained, the ingestion module 310 may calculate some or all of the metrics. Furthermore, the ingestion module 310 may create additional secondary metrics using metrics obtained from external sources. For example, if the ingestion module 310 retrieves daily mean prices from a market data datastore, the ingestion module may calculate weekly and monthly mean prices from the daily mean prices. The ingestion module 310 may store a local copy of the obtained data and any calculated metrics.

In some cases, the ingestion module 310 may create data structures that store representations of data objects 132 in formats usable by the query module 122. For instance, the ingestion module 310 may generate an embedding representing each data object. An embedding is a quantitative representation of the data object, and the information in the embedding represents, e.g., the content and syntax of the information in the data object 132. These embeddings are generated through the training process where a language model learns to associate linguistic patterns, information content and context, and relationships in a data object to various to similar patterns in a training dataset of data objects. Thus, when given an input data object, the ingestion module 310 computes a contextualized representation (e.g., embedding) of the data object based on the training data objects it has already contextualized. The query module 122 may then leverage the higher dimensional representation of information in a data object 132 to assess the likelihood that the data object 132 (or portions thereof) is relevant to a query request.

The query module 122 includes a filtering module 320. The filtering module 320 creates filters for searching data objects 132 based on a query request. To expand, recall how traditional RAG systems can fail whenever they are not appropriately directed towards the correct domain. For instance, a request for information about “tape pricing” could lead to information retrieval about adhesives, storage mediums, or recording. Without a method to adapt the domain to the correct context, the RAG process may select incorrect information for processing. Given this, at a high level, the filtering module 320 creates filters that shape the domain of the RAG process. Typically, the filters are configured to select some subset of data objects 132 from aggregate database 140 for processing the query request.

Filtering module 320 can generate filters in a variety of ways.

In a first example, filtering module 320 can receive a filter (or set of filters) from client device 110. The received filter may be included in the query request or may be otherwise provided. As an example, a user of client device 110 may expressly define a filter for all data objects 132 within a period, or from a previous date up to current time. As additional example, a user may define e.g., an approximate domain (finances, engineering, medicine, etc.), a type of data object 132 for processing, etc.

In a second example, the filtering module 320 may define a filter based on the received query request. As an example, consider a query request that is a natural language request for information. The filtering module 320 may process the natural language request identify contextual information that may be associated with domain indicating filters. To do so, the filtering module 320 may apply a large language model (or some other model) configured to identify contextual information in a natural language request relevant for generating filter. To illustrate, consider a query request including the following natural language request for information: “Compare the strength of American tape brands over the past ten years, give the profitability of each brand over the same period.” Filtering module 320 applies a large language model to the natural language query to identify filters. In this case, filtering module 320 identifies an appropriate domain filter because the word “adhesives” indicates a contextual understanding of “tape,” and words “ten years” indicate a time period to search for relevant information.

In a third example, the filtering module 320 may define a filter based on contextual information of the client device 110 or its user. For example, if the user is associated with work in the financial sector (e.g., via user associated metadata), the filter may preferentially define the domain to the financial sector. Similarly, if a client device 1110 is associated with a specific domain (e.g., via user data, hardware, etc.), the filtering module 320 may define a filter based on that.

The above examples of generating filters are not intended to be limiting, and the filtering module 320 may also use other methods of defining filters that aid in determining the contextual domain of the query request such that it may appropriately select data objects for query processing. Moreover, the filtering module 320 can use a combination of filters, as appropriate, depending on the configuration of the network system 120.

Query module 122 includes a selection module 330. The selection module selects data objects, or portions of data objects, relevant to (or responsive to) the query request, and aggregates those data objects to an aggregate data object. In some configurations, the selection module 330 selects only from those data objects 132 in the aggregate database 140 adhering to a filter determined the filtering module 320. Overall, at a high level, the selection module 330 searches data objects 132 in the appropriate domain (rather than all domains) for information pertaining to the query search.

To search the data objects 132, the selection module 330 employs an embedding based search given the search query. That is, the selection module 330 generates an embedding representing the information request in the query request. The embedding is a higher dimensional representation of the search query that is a quantitative representation of its content and syntax. The selection module 330 compares the embedding for the search request to embeddings for data objects 132 and portions of data objects 132 to identify data objects that may have information pertinent to the query request (e.g., because the embeddings are similar).

The selection module 330 identifies some number of data objects 132 or data object portions 132 as relevant data objects or data object portions. Relevant data objects are those identified as having a high likelihood of having information pertinent to (or responsive to) the request for information. The selection module 330 can identify relevant data objects by calculating a relevancy score of that data object 132. A relevancy score is a quantitative measurement representing the likelihood the data object 132 includes information pertinent to (or responsive to) the request for information. The relevancy score can be calculated as, e.g., a cosine similarity score between the embeddings, a probability score representing a likelihood the data objects 132 includes pertinent information, or some other metric that measures similarity.

The selection module 330 may determine that data objects are relevant data objects based on the relevancy score in several ways. In a first example, the selection module 330 ranks all the data objects 132 according to their relevancy score and selects all data objects 132 above a threshold ranking as relevant data objects (e.g., the top ten). In a second example, the selection module 330 selects all data objects 132 having a relevancy score above a threshold relevancy score. In a third example, the selection module 330 selects data objects based until an aggregate data object size is achieved. That is, the selection module 330 will select the highest ranked data objects until the size of the selected data objects reaches a threshold. Other methods are also possible.

The selection module 330 generates an aggregate document based on the selected data objects 132. That is, the selection module 330 extracts the data objects and portions of data objects 132 identified as relevant to the request for information to create an aggregate data object. The aggregate data object includes all the data from the relevant data objects. Due to the filtering and selection process, the aggregate data object has a high probability of including domain specific information that is pertinent to (or responsive to) the request for information.

The query module 122 includes a response module 340. The response module 340 generates a response for to the request for information present in the query request. To do so, the response module 340 accesses the natural language request for information present in the query response. The response module 340 inputs the natural language and the aggregate data object into an information retrieval model (e.g., an LLM). For example, in the case of an LLM, the aggregate document may be used as an input for a RAG assisted information retrieval. Thus, the LLM takes the natural language request for information, identifies the content, context, and intent of the natural language request for information, and uses the relevant information in the aggregate document to provide a response to the request for information. Because the aggregate document includes information that has a high probability of being relevant to the domain of the request for information, the information retrieval model also has a higher probability of providing a contextually, semantically, and intentionally relevant response to the request for information (because its RAG data set is localized to the domain).

The response module 340 generates a query response using the response generated by the information retrieval model. In some cases, the query response is the response generated by the information retrieval model. However, in some configurations, the response module 340 can perform additional functions to tailor the query response as needed. For example, the response module 340 can summarize the response, generate a visualization based on the response, identify and provide data cited in the response, etc. Whatever the case, the response module 340 provides a query response that provides a response to the request for information.

### Sentiment Module

As described above, network system 120 includes sentiment module 124. The sentiment module 124 determines the sentiment of data objects 132 in the aggregate database 140. The network system 120 may leverage the determined sentiment in generated a query response to a query request.

As used herein, sentiment in a data object 132 refers to the expression of emotions, feelings, attitudes, opinions, etc. embedded within data object. For example, text in a document, spoken words in a video, iconography in an image, etc. may contain sentiment about something in that data object 132. Sentiment within data objects 132 may be used classify these sentiments into categories like positive, negative, or neutral. However, additional sentiments such as risky, safe, stable, unstable, etc. are also possible. The sentiment in a data object 132, or collection of data objects (e.g., aggregate database 140), can be used to gauge public opinion, user satisfaction, system capability, etc., of information within the data object 132, thereby enabling network system 120 to more accurately respond to a query request. Therefore, when network system 120 leverages sentiment module 124 to determine the sentiment of a data objects 132 it is determining the general disposition of relevant information within the data objects 132 and responding to queries based on that disposition. For example, for a query request about an entity, the sentiment module 124 may determine, based on relevant data objects, that the entity has a high-risk profile but is well respected by the public, and may generate a response to a query reflecting or incorporating that sentiment.

In an example configuration, sentiment module 124 may leverage a large language model to determine the sentiment of data objects 132. To do so, sentiment module 124 may generate a prompt configured to tune the context window of the large language model for sentiment analysis. For example, the prompt may provide one or more of (1) sentiment levels (e.g., positive, neutral, negative), (2) sentiment targets-the things for which sentiment will be analyzed (e.g., entity A, metric B, etc.), (3) sentiment factors-information for which sentiment level will be determined (e.g., risk, public sentiment, etc.), etc. To illustrate, a prompt may ask whether the risk sentiment for an entity is high, medium, or low, or a prompt may ask whether the public opinion for a metric is positive, neutral, or negative.

Moreover, the prompt configured to increase a likelihood of an accurate sentiment determination. For example, the prompt may include (1) a request for providing the reasoning for the determined sentiment level, (2) a request for identifying the portions of the data object leading to the sentiment determination, (3) a request for the reasoning behind the sentiment, (4) an instruction to double check the determines sentiment, etc. To illustrate, a prompt may request that sentiment module 124 provide a reasoning for its determined risk sentiment analysis and provide the sections of the relevant documents that are used in the determination.

In practice, determining the sentiment for a relevant document uses the large-language model approaches discussed above. That is, sentiment module 124 generates a prompt based on the concepts described above and generates an embedding reflecting that prompt. The sentiment module 124 inputs the embedding representing the prompt and the embedding representing a relevant document into the large language model and the large language model outputs the determined sentiment. The large language model, in effect, makes a probabilistic determination of the sentiment based on the semantic and syntactic content of the prompt and the relevant documents or document portions. Generally, the output sentiment is a natural language representation of the sentiment in the relevant document, but could also be some other quantitative or qualitative measure of sentiment.

Sentiment module 124 may also determine an aggregate sentiment across a range of relevant documents. In this case, sentiment module 124 may determine a sentiment level for a relevant document and a corresponding sentiment score for some larger set of relevant documents. For example, consider a set of relevant documents including Documents A, B, C, D, and E. Sentiment module 124 may determine the sentiments are Positive, Neutral, Positive, Negative, and Positive, respectively, for the relevant documents. Given this, sentiment module 124 may determine that the sentiment score (e.g., an aggregate sentiment) for the relevant documents is positive. To generate the sentiment score, sentiment module 124 may also leverage the large language model techniques for aggregation described herein. For example, sentiment module 124 may generate an embedding representing each sentiment level and input the factors into an LLM with a prompt requesting a sentiment score, and the LLM outputs a sentiment score.

In some configurations, rather than individually determining sentiment levels, sentiment module 124 may directly determine a sentiment score. For example, query module 122 may generate and aggregate document based on a corpus of relevant data and sentiment module 124 may determine the sentiment of the aggregate document.

Query module 122 may leverage the determined sentiment in generating a query response. For example, query module 122 may input the sentiment score, the aggregate document, and the natural language query for information into a model (e.g., an LLM). The model provides a query response including the requested information. Given than an input to the model included the sentiment score, the output query response may reflect that sentiment. For instance, in a request for information about an entity, the response may include, or be colored by, the determined sentiment score.

Query module query module 122 may also leverage the determined sentiment to generate one or more inferences as part of a query response. For example, if the request for information includes, e.g., a request for a predicted or future state of Metric A, then the query response for the predicted or future state of Metric A may be an inference based on the determined sentiment. To illustrate, for a determined sentiment indicating a variability or risk factor for Metric A is high, the determined inference may be, e.g., lower than expected due to that sentiment.

### III. Example Workflows

### First Example Workflow

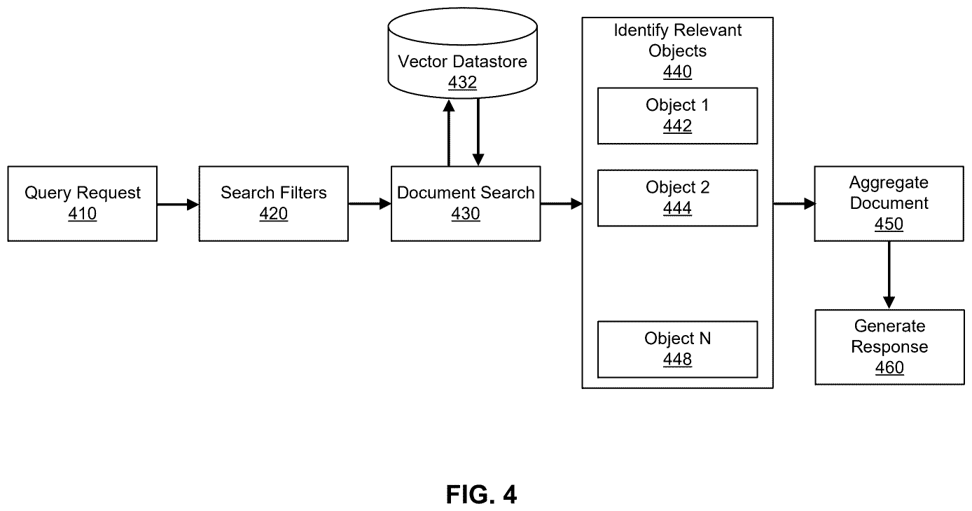

FIG. 4 illustrates an example workflow of a query module providing query response in response to receiving a database query, according to an example embodiment.

In the example embodiment shown in FIG. 4, the query module 122 receives a query request 410. Query module 122 receives the query request from client device 110, and the query request includes a natural language request for information from data objects 132 in aggregate database 140.

Query module 122 determines search filters 420 for the query request. To do so, in this case, query module 122 applies a language model to the query request to identify, e.g., a time period, an enterprise system 130, and a domain indicator for searching based on the content and context present in the natural language request for information. The query module 122 also identifies additional domain indicators based on metadata associated with the requesting client device 110 and/or user operating the client device 110.

Query module 122 searches aggregate database 140 for data objects 132 relevant to the request for information. In some configurations, query module 122 only searches those data objects that adhere to the determined search filter. To perform the search, query module 122 generates a vector representing the natural language request for information (e.g., a vector).

Query module 122 performs a vector search of the vector datastore 432 to identify relevant data objects 132 or portions of the data objects 132. To do so, query module 122 compares the vector of the natural language request for information to vectors representing data objects 132 and portions of data objects 132.

Query module 122 identifies data objects 132 or portions of data objects 132 having a sufficient similarity to the vector representing the natural language request for information as relevant data objects 440. For example, object 1, object 2, and object N are identified as relevant data objects based on the vector search of the vector datastore.

Query module 122 generates an aggregate data object from the relevant data objects (e.g., relevant objects 442, 444, 446). The aggregate data object is a data object that includes all of the information included in the data objects 132 or portions of data objects 132 identified as relevant.

Query module 122 generates a response to the natural language request for information. To do so, the query module 122 utilizes a RAG enhanced LLM approach-using both the aggregate document and the natural language request for information as an input to a large language model. The large language model processes the aggregate document and natural language request for information to generate a response. The response provides the requested information as a response to the natural language request for information. Query module 122 generates a query response for the client device 110 that includes the response to the request for information.

### Second Example Workflow

As noted above, query responses using traditional RAG assisted LLMs have many shortcomings that stem from, e.g., lack of domain awareness, contextual misunderstandings, and poorly tailored information input. To illustrate, consider, for example, a query request that includes a natural language request for information that compares, e.g., Metric A and Metric B from Entity A and Entity B. Traditional approaches have trouble approaching this problem due to the multi-faceted nature of its domain context. Traditional systems, when seeking to identify relevant documents for RAG, have trouble identifying relevant data objects that can provide an accurate response to the natural language request for information. For instance, traditional systems may try to find relevant data objects that include all the information (e.g., Metric A, Metric B, Entity A, Entity B) when such a data object does not exist, identifies data objects that do not adhere to the appropriate context (e.g., compare Metric A and B for Entity A, and Entity B only provides analysis), or data objects that are not within the relevant domain (e.g., identifies Metric A for Entity A′, which shares the name as Entity A but is in a different field).

To alleviate this problem, query module 122 may be configured to generate one or more sub-queries based on the query request. A sub-query are those requests generated when query module 122 breaks down a multi-faceted natural language request for information in a query request into smaller, more accomplishable requests for information. For example, consider again, the natural language request for information comprising, “Provide a comparison of Metric A and Metric B between Entity A and Entity B.” Query module 122 may generate sub-queries tailored that, in aggregate, target the higher-level contextual question in the request for information. For instance, query module 122 may generate four sub-queries, including, e.g., “What is Metric A for Entity A?”, “What is Metric B for Entity A?”, “What is Metric A for Entity B?” and “What is Metric B for Entity B?”.

Query module 122 may generate document search filters and embeddings of each sub-query and identify relevant data objects 132 from the aggregate database 140 for each sub-query. Further, query module 122 may generate and aggregate document for each sub-query and utilize RAG assisted LLM to generate a response to each sub-query. As such, the query module 122 may identify a response to each of the smaller, particularized subqueries. Once the particularized responses to sub queries are identified, query module 122 may generate a response to the query request using those particularized response. For example, the query module 122 may input each of the sub-query responses and the original request for information into the information retrieval model (e.g., an LLM) and the model provides a response based on the responses to the sub-queries.

Using this methodology has obvious benefits. The query module 122 breaks down complex, multi-faced contextual requests for information into smaller, easier to understand and process sub-queries. Providing a response to the particularized sub-queries, rather than trying to answer the request all at once, has a higher likelihood of providing an accurate response to the natural language request for information. Using the more accurate responses to sub-queries as inputs for the generating a query response for information provides a higher likelihood of an accurate response to the more contextually complex request for information.

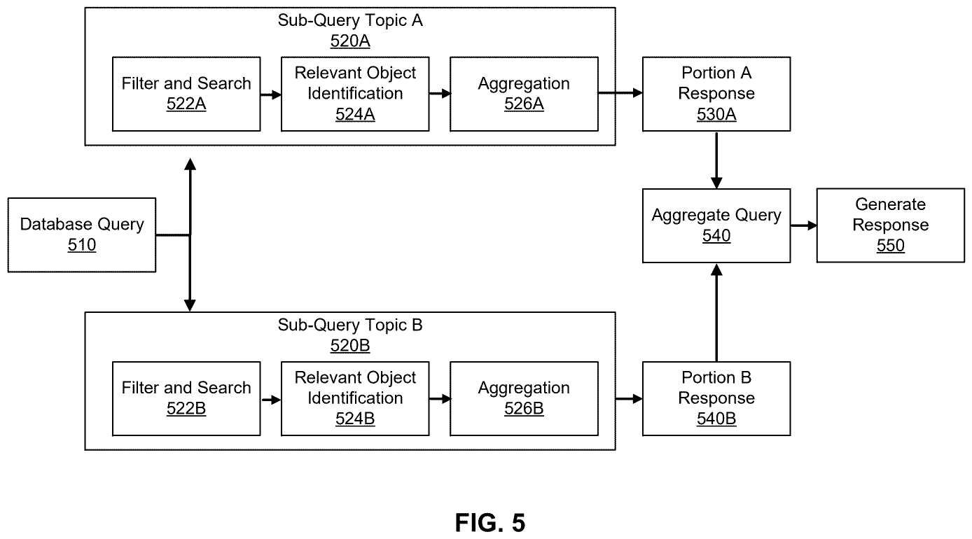

FIG. 5 illustrates an example workflow of a query module providing a query response in response to receiving a query request, according to an example embodiment.

In the example embodiment shown in FIG. 5, the query module 122 receives a query request 510. Query module 122 receives the query request from client device 110. The query request includes a natural language request for information from data objects 132 in aggregate database 140.

In this example, the request for information about two topics (e.g., a comparison of Metric A and Metric B at Entity C). As such, query module 122 generates two sub-queries-a sub-query for topic A 520A (e.g., What is Metric A for Entity C?”) and a sub-query for topic B 520B (e.g., “What is Metric B for Entity C?”). To generate the sub-queries, query module 122 may apply a large language model to the natural language request.

Query module 122, as described above, generates a data object filter, applies the filter to data objects 132, and searches those data objects 522 (for both the sub-query for topic A 522A and the sub-query for topic B 522B).

Based on the search, the query module 122 identifies relevant data objects or data object portions 524 (for both the sub-query for topic A 524A and the sub-query for topic B 524B).

Query module 122 generates an aggregate data object using the data objects or data object portions identified as relevant 526 (for both the sub-query for topic A 526A and the sub-query for topic B 526B).

Query module 122 inputs the aggregate data object and the sub-query into a response identification model (e.g., an LLM) to generate a response to the sub-query 530 (for both the sub-query for topic A 530A and the sub-query for topic B 530B).

Query module 122 generates an aggregate query. The aggregate query may include both the response to sub-query A, the response to sub-query B, and the original request for information. Query module 122 applies a model (e.g., an LLM) to the aggregate query to generate a response to the natural language request for information. Query module 122 generates a query response for the client device 110 that includes the response of the aggregate query.

Of course, this process can be expanded for N sub-queries, and may have to generate any number of aggregate queries at different levels (depending on the complexity of the natural language request for information). For example, considering the first example with two topics being compared between two entities, there may be two levels of aggregate queries. The first level includes aggregate queries that compare Metric A between Entity A and Entity B and Metric B between Entity A and Entity B, and a second level of aggregate queries that generates a response combining those two responses.

### Third Example Workflow

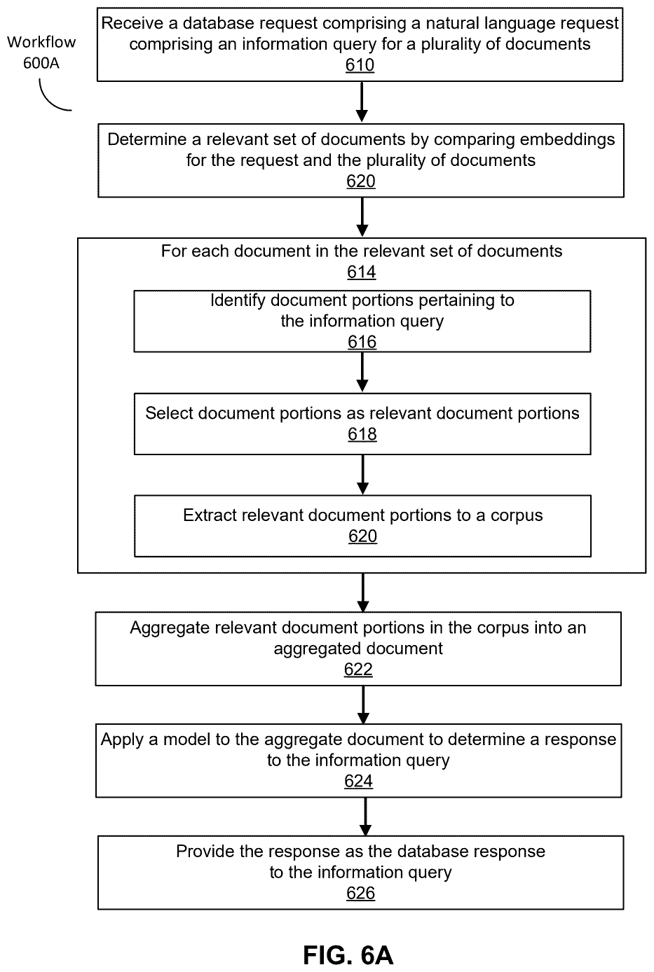

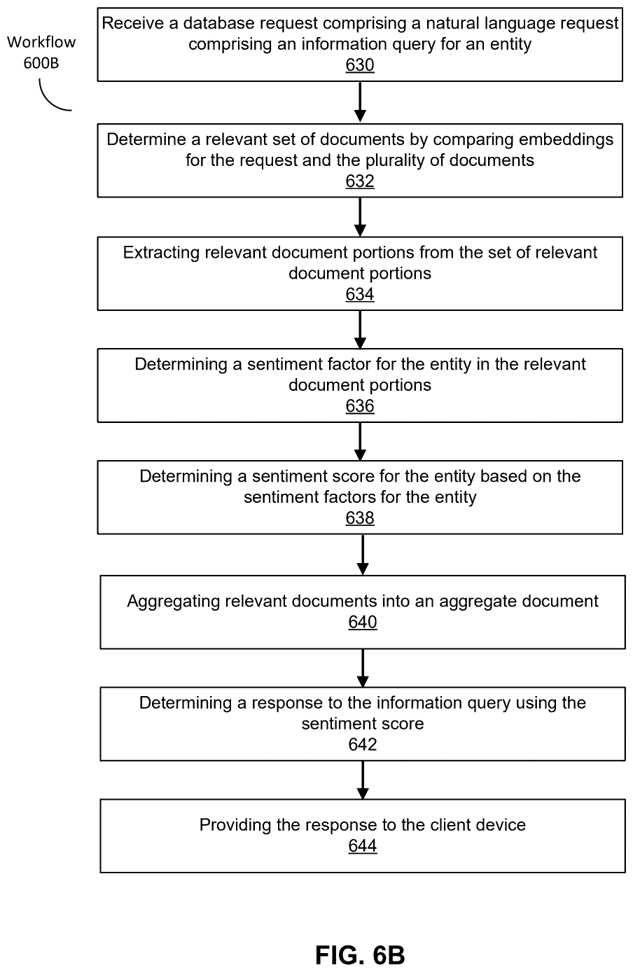

FIG. 6A shows a workflow for generating a database response to an information query, according to an example embodiment. The workflow 600 may include additional or fewer steps, and some steps may be repeated. Moreover, steps in the workflow may occur in a different order or may be combined, depending on the configuration of the network system.

A network system (e.g., network system 120) receives 610 a database request (e.g., a query request) from a client device (e.g., client device 110). The database request includes the information query, and the information query is a natural language request for information from data objects (e.g., data objects 132) in a database (e.g., aggregate database 140). In this case, the data objects are documents stored across enterprise systems (e.g., enterprise system 130) within a system environment (e.g., system environment 100).

In some configurations, the network system, using a query module (e.g., query module 122), generates data object search filters. Data object search filters are configured to identify those documents in the database that, at a high level, are likely to include information pertinent to (or response to) the information query. Generating search filters may include applying a large language model to the information query to dynamically generate search queries or accessing search filters received from the client device.

The network system, using the query module, identifies 612 relevant documents in the database. To identify relevant documents, the network system compares an embedding representing the information query to embeddings representing the documents. By comparing the embeddings, the networks system identifies documents that have content similar to the content of the information query. In configurations where filters are employed, relevant documents are only those that also adhere to the filter criteria.

For each of the relevant documents 614, the network system, using the query module, identifies 616 document portions in each document that has information pertaining to (or responsive to) the information query. The network system may select 618 one or more of the document portions as relevant document portions. Relevant document portions are those document portions that have a high likelihood of having information that provides at least a partial response to the information query. Again, the network system may identify the document portions and relevant document using an embedding comparison. Therefore, at a high level, the relevant document portions may be viewed as those document portions whose embeddings are most like the embedding for the information query. The network system extracts 612 relevant document portions from the relevant documents to a data corpus of relevant documents.

The network system aggregates 622 the relevant document portions in the corpus into an aggregated document. The aggregated document, therefore, has a high likelihood of containing information that provides at least a partial response to the information query.

The network system applies 624 a large language model to the aggregated document to determine a response to the information query. That is, the network system inputs (1) the natural language query for the request for information, and (2) the aggregated document including information having a high likelihood of including at least a partial response to the information query into an LLM. The LLM processes the content, content, and intent of the information query in view of the information in the aggregated document to determine a response to the information query.

The network system provides 626 the response to the information query as a database response to the requesting client device.

As noted above, some the workflow may be different than what is illustrated in FIG. 6A. For instance, in some configurations, rather than identifying relevant documents and the identifying relevant document portions from those relevant documents, the network system may directly identify relevant document portions. Additionally, in some configurations, the workflow may include generating sub-queries from the information request and identifying relevant document portions for those sub-queries (see., e.g., FIG. 5).

### Fourth Example Workflow

FIG. 6B shows a workflow for generating a database response to an information query about an entity, according to an example embodiment. The workflow 600B may include additional or fewer steps, and some steps may be repeated. Moreover, steps in the workflow may occur in a different order or may be combined, depending on the configuration of the network system.

A network system (e.g., network system 120) receives 630 a database request (e.g., a query request) from a client device (e.g., client device 110). The database request includes the information query about an entity. The information query is a natural language request for information from data objects (e.g., data objects 132) in a database (e.g., aggregate database 140) that includes information about the entity. In this case, the data objects are documents stored across enterprise systems (e.g., enterprise system 130) within a system environment (e.g., system environment 100).

In some configurations, the network system, using a query module (e.g., query module 122), generates data object search filters. Data object search filters are configured to identify those documents in the database that, at a high level, are likely to include information pertinent to (or response to) the information query (e.g., about the entity). Generating search filters may include applying a large language model to the information query to dynamically generate search queries or accessing search filters received from the client device.

The network system, using the query module, identifies 632 relevant documents in the database. To identify relevant documents, the network system compares an embedding representing the information query to embeddings representing the documents. By comparing the embeddings, the networks system identifies documents that have content relevant to the information query (e.g., about the entity). The network system extracts 634 relevant document portions from the identified set of relevant documents. The network system may do so using a process similar to the extraction steps of workflow 600A (e.g., 614-620).

The network system determines 636 a sentiment level for each of the relevant document portions. To do so, the network system, using a sentiment module (e.g., sentiment module 124), may generate a prompt configured to determine the sentiment and generates an embedding representing the prompt. The network system inputs the embeddings representing he prompt and embeddings representing the relevant document portions into a model, and the model outputs the sentiment levels. The network system determines 638 a sentiment score based on the determined sentiment levels. Determining the sentiment score may include generating a prompt and embedding configured to determine an aggregate sentiment based on the sentiment levels.

The network system aggregates 640 the relevant document portions in the corpus into an aggregated document. The aggregated document, therefore, has a high likelihood of containing information that provides at least a partial response to the information query.

The network system determines 642 a response to the information query using the sentiment score and aggregate document. To do so, the network system applies a large language model to the aggregated document and sentiment query to determine a response to the information query. That is, the network system inputs (1) the natural language query for the request for information, (2) the aggregated document including information having a high likelihood of including at least a partial response to the information query, and (3) the determined sentiment score into an LLM. The LLM processes the content, content, sentiment and intent of the information query in view of the information in the aggregated document and sentiment level to determine a response to the information query.

The network system provides 644 the response to the information query as a database response to the requesting client device.

### IV. Computer System

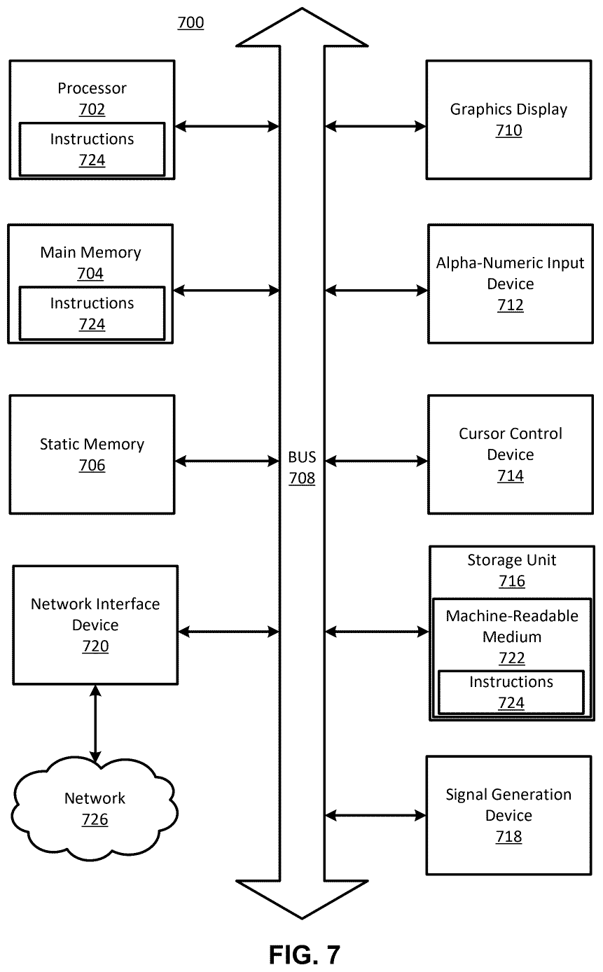

FIG. 7 is a block diagram illustrating components of an example machine for reading and executing instructions from a machine-readable medium, according to an example embodiment. Specifically, FIGS. 1-3 show a diagrammatic representation of computer systems employed throughout the Specification. These systems can be in the example form of a computer system 700. The computer system 700 can be used to execute instructions 724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client system environment 100, or as a peer machine in a peer-to-peer (or distributed) system environment 100.

The machine may be a server computer, a client computer, a personal computer (PC), a tablet PC, a set-top box (STB), a smartphone, an internet of things (IoT) appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processing units (generally processor 702). The processor 702 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 700 also includes a main memory 704. The computer system may include a storage unit 716. The processor 702, memory 704, and the storage unit 716 communicate via a bus 708.

In addition, the computer system 700 can include a static memory 706, a graphics display 710 (e.g., to drive a plasma display panel (PDP), a liquid crystal display (LCD), or a projector). The computer system 700 may also include alphanumeric input device 712 (e.g., a keyboard), a cursor control device 714 (e.g., a mouse, a trackball, a joystick, a motion sensor, or other pointing instrument), a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. For example, the instructions 724 may include the functionalities of modules of the systems described in FIG. 1. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 may be transmitted or received over a network 726 (e.g., network 150) via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

1. A method for generating a database response for an information query, the method comprising:
receiving, at a network system from a client device, a database request comprising the information query, wherein the information query is a natural language request for information from for a plurality of documents in a document database, and the information query comprises a request to compare a first topic and a second topic;
generating, based on the request to compare the first topic to the second topic,
a first sub-query configured identify relevant information regarding the first topic. and
a second sub-query configured to identify relevant information regarding the second topic;
determining a relevant set of documents from the plurality of documents in the document database, the relevant documents determined by comparing a data structure representation of the natural language request for the information query, the first sub-query, and the second sub-query to a data structure representation of a content of each document in the plurality of documents;
for each document in the relevant set of documents:
identifying a plurality of document portions in the document pertaining to the information query based on the first sub-query and the second sub-query;
selecting one or more document portions of the plurality of document portions as relevant document portions, the relevant document portions providing at least a partial response to the information query based on the first sub-query and the second sub-query; and
extracting the relevant document portions providing at least a partial response to the information query to a corpus of relevant document portions, wherein:
each relevant document portion has a similarity score representing a similarity between the data structure representation of the information query and a data structure representation of the document portion, and
document portions having a similarity score above a threshold score are extracted to the corpus;
aggregating the relevant document portions in the corpus into an aggregated document;
applying a large language model to the aggregated document to determine a response to the information query; and
providing, from the network system to the client device, the response to the information query as the database response.

2. (canceled)

3. (canceled)

4. The method of claim 3, wherein identifying a set of relevant documents comprises:
selecting a first subset of documents of the plurality by comparing embeddings generated to represent the first sub-query to embeddings representing the content of each document in the plurality of documents; and
selecting a second subset of documents of the plurality by comparing embeddings generated to represent the second sub-query to embeddings representing the content of each document in the plurality of documents.

5. The method of claim 4, wherein extracting relevant document portions providing at least the partial response to the information query comprises:
identifying a first subset of document portions in the first subset of documents pertaining to the first sub-query;
selecting a first set of relevant document portions from the first subset of document portions that provide at least a partial response to the first sub-query; and
extracting the first set of relevant document portions providing at least the partial response to the first sub-query to the corpus of relevant document portions.

6. The method of claim 5, wherein extracting relevant document portions providing at least the partial response to the information query comprises:
identifying a second subset of document portions in the second subset of documents pertaining to the second sub-query;
selecting a second set of relevant document portions from the second subset of document portions that provide at least a partial response to the second sub-query; and
extracting the second set of relevant document portions providing at least the partial response to the second sub-query to the corpus of relevant document portions.

7. The method of claim 6, wherein applying the large language model to the aggregated document to determine the response to the information query comprises:
determining a first response to the first sub-query;
determining a second response to the second sub-query; and
generating the response based of the first response and the second response.

8. The method of claim 1, wherein identifying the plurality of document portions, selecting the one or more document portions, and extracting the relevant document portions providing at least a partial response to the information query to the corpus of relevant document portions comprises performing retrieval augmented generation.

9. (canceled)

10. (canceled)

11. A method for generating a database response for an information query for an entity, the method comprising:
receiving, at a network system from a client device, a database request comprising the information query, wherein the information query is a natural language request for information from for a plurality of documents in a document database, and the information query comprises a request to compare a first topic and a second topic;
generating, based on the request to compare the first topic to the second topic,
a first sub-query configured identify relevant information regarding the first topic, and
a second sub-query configured to identify relevant information regarding the second topic;
determining a relevant set of documents from the plurality of documents in the document database, the relevant documents determined by comparing a data structure representation of the natural language request for the information query, the first sub-query, and the second sub-query to a data structure representation of a content of each document in the plurality of documents;
for each document in the relevant set of documents:
identifying a plurality of document portions in the document pertaining to the information query based on the first sub-query and the second sub-query;
selecting one or more document portions of the plurality of document portions as relevant document portions, the relevant document portions providing at least a partial response to the information query based on the first sub-query and the second sub-query; and
extracting the relevant document portions providing at least a partial response to the information query to a corpus of relevant document portions, wherein:
wherein:
each relevant document portion has a sentiment score representing determined sentiment levels towards the entity, the sentiment score determined based on the data structure representation of the information query and a data structure representation of the document portion, and
document portions having a sentiment score above a threshold score are extracted to the corpus;
aggregating the relevant document portions into an aggregate document;
determining, by applying a large language model to the aggregated document, a response to the information query about the entity, wherein the response determination uses the sentiment score for the entity;
providing, from the network system to the client device, the response to the information query for the entity as the database response, wherein the response reflects the sentiment score for the entity.

12. (canceled)

13. (canceled)

14. The method of claim 11, further comprising:
determining, based on the natural language in the natural language request, a sentiment factor for determining sentiment levels in the set of relevant documents.

15. The method of claim 14, wherein the sentiment factor is entity risk or public opinion.

16. The method of claim 11, wherein the sentiment score is an aggregation of the sentiment levels from the set of relevant document portions.

17. The method of claim 11, wherein determining sentiment levels for each of the relevant document portions comprises generating a prompt for the large language model configured to increase a likelihood of accurate sentiment determination.

18. The method of claim 17, wherein the prompt comprises a request for providing a reasoning for the determined sentiment level.

19. The method of claim 17, wherein the prompt comprises a request for identifying portions relevant document portions leading to determined sentiment level for the document portion.

20. The method of claim 11 wherein determining the sentiment score for the entity based on the sentiment levels comprises applying the large language model to the sentiment levels.

21. The method of claim 1, wherein determining the relevant set of documents from the plurality of documents in the document database comprises:
applying a large language model to the plurality of documents to generate the data structure representation of the content of each document in the plurality of documents; and
applying the large language model to the plurality of documents to generate the data structure representation of the natural language request.

22. The method of claim 21, wherein the data structure representation of the content of each document in the plurality of documents is an embedding.

23. The method of claim 21, wherein the data structure representation of the content of the natural language request is an embedding.
